(19) United States
(12) Patent Application Publication
(10) Pub. No.: US 2026/0302458 A1
(43) Pub. Date: Oct. 1, 2026

(54) SEALING DEVICE AND SEALING METHOD

(71) Applicant: SK On Co., Ltd., Seoul (KR)

(72) Inventors: Woo Seop KIM, Daejeon (KR); Sang Jo MOON, Daejeon (KR); Joo Eun LEE, Daejeon (KR); Sang Hoon RYU, Daejeon (KR); Won Seok CHOI, Daejeon (KR)

(21) Appl. No.: 19/634,103

(22) Filed: Mar. 31, 2026

(30) Foreign Application Priority Data
Mar. 31, 2025 (KR) 10-2025-0041267

(51) Int. Cl. H01M 50/188

(52) U.S. Cl. CPC H01M 50/188

(57) ABSTRACT

A sealing device for a battery cell including an exterior material that forms an accommodating space accommodating an electrode assembly therein and a terminal portion that is connected to the electrode assembly and protrudes to an outside of the exterior material is provided. The sealing device includes a first pressing portion and a second pressing portion disposed to face each other with at least a portion of the exterior material interposed therebetween to contact a sealing portion that is formed on the at least the portion of the exterior material along a periphery of the accommodating space to seal the accommodating space, and a lifting portion for moving the first pressing portion toward or away from the second pressing portion to contact the sealing portion disposed at the first pressing portion and the second pressing portion.

### CROSS-REFERENCE TO RELATED PATENT APPLICATION

The present disclosure claims priority under 35 U.S.C. § 119(a) to Korean patent application number 10-2025-0041267, filed on Mar. 31, 2025, in the Ministry of Intellectual Property, the entire disclosure of which is incorporated by reference herein.

### BACKGROUND OF THE INVENTION

### 1. Field

Various embodiments of the present disclosure generally relate to a sealing device and a sealing method.

### 2. Description of the Related Art

In contrast to primary batteries, secondary batteries may be charged and discharged, and thus may be applied to various fields such as digital cameras, cell phones, laptops, hybrid vehicles, and electric vehicles. Among secondary batteries, lithium secondary batteries with high energy density and high discharge voltage have been actively researched in recent years.

Generally, lithium secondary batteries are manufactured in the form of flexible pouch-type battery cells, rigid prismatic battery cells, or cylindrical can-type battery cells.

Among the above-described types of battery cells, a manufacturing process of the pouch-type battery cells is described schematically as follows: first, an electrode assembly including terminal portions are jointed thereto are disposed in an accommodating space of an exterior material. Then, the exterior material is partially sealed to form the exterior material in the form of a pouch with one open side. Then, an electrolyte solution is injected into the exterior material through the one open side, and when the electrolyte solution injection is completed, a process of sealing the one open side is performed sequentially.

### SUMMARY OF THE INVENTION

According to an aspect of the present disclosure, an object is to provide a sealing device and a sealing method having improved ease of use.

According to another aspect of the present disclosure, an object is to provide the sealing device and the sealing method having improved accuracy.

According to still another aspect of the present disclosure, an object is to provide the sealing device and the sealing method having relaxed constraints on a sealing position.

The battery assembly according to the present disclosure may be widely applied in the green technology fields such as electric vehicles, battery charging stations, and other technologies using batteries such as photovoltaics and wind power. Furthermore, the battery assembly according to the present disclosure may be used for eco-friendly electric and hybrid vehicles to reduce air pollution and greenhouse gas emissions to prevent or mitigate climate change.

In a sealing device for a battery cell including an exterior material that forms an accommodating space accommodating an electrode assembly therein and a terminal portion that is connected to the electrode assembly and protrudes to an outside of the exterior material, the sealing device according to the present disclosure may include a first pressing portion and a second pressing portion disposed to face each other with at least a portion of the exterior material interposed therebetween to contact a sealing portion, wherein the sealing portion is formed on the at least the portion of the exterior material along a periphery of the accommodating space to seal the accommodating space, and a lifting portion for moving the first pressing portion toward or away from the second pressing portion to contact the sealing portion disposed at the first pressing portion and the second pressing portion.

In an embodiment, the first pressing portion may include a first wing portion extending along a direction in which the terminal portion protrudes, a second wing portion extending along the direction in which the terminal portion protrudes and disposed to be spaced apart from the first wing portion, and a first connection portion disposed to be spaced apart from the battery cell and connecting the first wing portion and the second wing portion. The second pressing portion may include a third wing portion and a fourth wing portion disposed to face the first wing portion and the second wing portion, and a second connection portion facing the first connection portion and connecting the third wing portion and the fourth wing portion.

In an embodiment, the first pressing portion may further include first sealing bars respectively disposed on one surface facing the third wing portion of surfaces of the first wing portion and on one surface facing the fourth wing portion of surfaces of the second wing portion. The second pressing portion may further include second sealing bars respectively disposed on one surface facing the first wing portion of surfaces of the third wing portion and on one surface facing the second wing portion of surfaces of the fourth wing portion.

In an embodiment, the first sealing bars and the second sealing bars may extend along a direction from the first wing portion toward the second wing portion or a direction from the third wing portion toward the fourth wing portion.

In an embodiment, along the direction in which the terminal portion protrudes, a length of each of the first sealing bars and the second sealing bars may be less than a length of the first wing portion, a length of the second wing portion, a length of the third wing portion, or a length of the fourth wing portion.

In an embodiment, along a direction from the first wing portion toward the second wing portion, a length of each of the first sealing bars may be less than or equal to a length of each of the first wing portion and the second wing portion, and, along a direction from the third wing portion toward the fourth wing portion, a length of each of the second sealing bars may be less than or equal to a length of each of the third wing portion and the fourth wing portion.

In an embodiment, the sealing device according to the present disclosure may further include an alignment portion located on an outer side of one of the first pressing portion and the second pressing portion for aligning the battery cell.

In an embodiment, the alignment portion may extend from the outer side of the second pressing portion along an extension direction of the first sealing bars or the second sealing bars and may be bent toward the first pressing portion.

In an embodiment, the first pressing portion may further include a first heater heating the first sealing bars. The second pressing portion may further include a second heater heating the second sealing bars.

In an embodiment, the sealing device according to the present disclosure may further include a power supply unit disposed closer to the second pressing portion than the first pressing portion and supplying stored power to the first pressing portion, the second pressing portion, or the lifting portion.

In an embodiment, the sealing device according to the present disclosure may further include an alignment sensor located on the first pressing portion or the second pressing portion and detecting whether the first pressing portion and the second pressing portion are aligned.

In an embodiment, the alignment sensor may be a gyro sensor.

In an embodiment, the sealing device according to the present disclosure may further include a measuring sensor located on one of one surface facing the second pressing portion of surfaces of the first pressing portion and one surface facing the first pressing portion of surfaces of the second pressing portion for measuring a thickness of the sealing portion.

In an embodiment, the second pressing portion may further include a grip portion provided to the second pressing portion to allow a user to grip.

In an embodiment, the grip portion may include a protrusion protruding from the second pressing portion and an extension extending along a direction from the first pressing portion toward the second pressing portion.

In an embodiment, the grip portion may be disposed in a direction opposite to the battery cell with respect to the first pressing portion and the second pressing portion.

In an embodiment, the sealing device according to the present disclosure may further include an input and output (input/output) unit located at one of the first pressing portion and the second pressing portion and receiving a command from the user.

In an embodiment, the input/output unit may include an input unit located at the grip portion and an output unit located at the first pressing portion.

In an embodiment, the lifting portion may include a first pillar portion and a second pillar portion disposed along an arrangement direction perpendicular to a direction from the first pressing portion toward the second pressing portion and a direction in which the terminal portion protrudes.

In an embodiment, the first pillar portion may be disposed close to one side surface of opposite side surfaces of the first pressing portion along the arrangement direction, and the second pillar portion may be disposed close to the other side surface of the opposite side surfaces of the first pressing portion along the arrangement direction.

According to an embodiment of the present disclosure, a sealing device and a sealing method may have improved ease of use.

According to another embodiment of the present disclosure, the sealing device and the sealing method may have improved accuracy.

According to still another embodiment of the present disclosure, the sealing device and the sealing method may be configured to reduce constraints on a sealing position.

### BRIEF DESCRIPTION OF THE DRAWINGS

FIG. 1 is a plan view illustrating a battery cell;

FIG. 2 is a perspective view illustrating a battery cell;

FIG. 3 is a perspective view illustrating a sealing device according to an embodiment of the present disclosure;

FIG. 4 is an exploded view illustrating a sealing device according to an embodiment of the present disclosure;

FIG. 5 is a cross-sectional view illustrating a sealing device according to an embodiment of the present disclosure;

FIG. 6 is a flowchart illustrating a sealing method according to an embodiment of the present disclosure;

FIG. 7 is a diagram illustrating a sealing method according to an embodiment of the present disclosure;

FIG. 8 is a diagram illustrating a sealing method according to an embodiment of the present disclosure;

FIG. 9 is a diagram illustrating a sealing method according to an embodiment of the present disclosure; and

FIG. 10 is a control block diagram of a sealing device according to an embodiment of the present disclosure;

FIG. 11 is a diagram illustrating sealing bars of a sealing device according to an embodiment of the present disclosure; and

FIG. 12 is a diagram illustrating sealing bars of a sealing device according to an embodiment of the present disclosure.

### DETAILED DESCRIPTION

Hereinafter, specific descriptions in accordance with the present disclosure are provided with reference to the accompanying drawings. It is noted, however, that the descriptions are merely illustrative and the present disclosure is not limited to specific embodiments described in this specification.

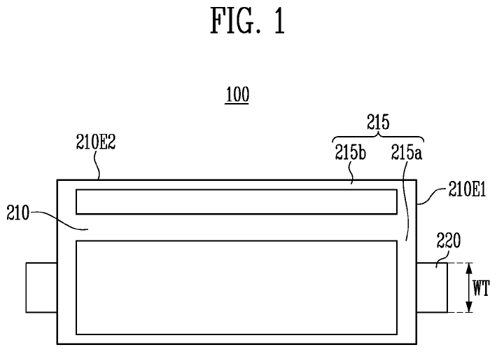

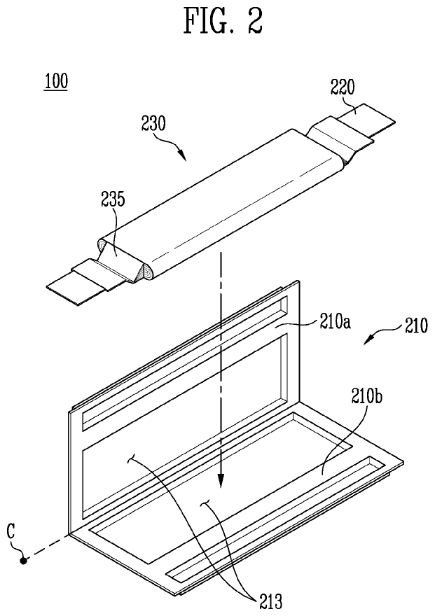

FIG. 1 is a plan view illustrating a battery cell. FIG. 2 is a perspective view illustrating a battery cell.

Referring to FIGS. 1 and 2, a battery cell 100 manufactured via a sealing device according to the present disclosure may include an electrode assembly 230 and an exterior material 210 surrounding the electrode assembly 230.

The battery cell 100 according to an embodiment of the present disclosure is a rechargeable cell, and may include a lithium-ion (Li-ion) battery or a nickel-metal hydride (Ni-MH) battery. The Ni-MH battery is a cell in which a positive electrode includes nickel, a negative electrode includes a hydrogen-absorbing alloy, and an alkaline aqueous solution is used as an electrolyte. The Ni-MH battery has a high capacity per unit volume, and thus can be used as an energy source for electric vehicles (EVs) or hybrid electric vehicles (HEVs), as well as in various fields such as energy storage.

The electrode assembly 230 is a member having a plurality of electrodes stacked together and may be formed in a roughly hexahedral shape and may be mounted with an electrolyte in an accommodating space 213 of the exterior material 210.

The exterior material 210 may be formed of a flexible film material. For example, the exterior material 210 may be formed of a material in which a surface of an aluminum foil is insulation-treated.

In other words, the exterior material 210 may be formed of a composite material. More specifically, the exterior material 210 may include a polypropylene (PP) layer contacting the electrolyte therein, a metal layer (e.g., aluminum) laminated on the PP layer, a nylon layer laminated on the metal layer, and a polyethylene terephthalate (PET) layer laminated on the nylon layer to form an outer surface of the sheath material.

The PP layer may be disposed at the innermost layer of the exterior material 210 in consideration of formability and electrolyte resistance of the exterior material 210. The metal layer may be used to maintain the mechanical strength of the exterior material 210. The nylon layer and the PET layer may be used to improve formability of the exterior material 210 and to suppress or reduce side reactions between the metal layer and external moisture.

The accommodating space 213 accommodating the electrode assembly 230 therein may be provided in the exterior material 210. A terminal portion 220 may protrude to an outside of the exterior material 210.

As shown in FIG. 2, the battery cell 100 according to an embodiment of the present disclosure may seal the accommodating space 213 by folding a single sheet of the exterior material and sealing three side surfaces. Thus, the exterior material 210 according to an embodiment of the present disclosure may be divided into a first exterior material 210a and a second exterior material 210b based on a bending line C along which the exterior material is folded.

Specifically, the battery cell 100 according to the present disclosure may be manufactured by mounting the electrode assembly 230 in the accommodating space 213, folding the exterior material along the bending line C, and then sealing the accommodating space 213 by sealing an edge where the first exterior material 210a and the second exterior material 210b meet.

The sealing method for the edge may include, but is not limited to, a thermal fusion method. Hereinafter, the bonded edge portion is referred to as a sealing portion 215.

In an embodiment of the present disclosure, the sealing portion 215 may be divided into first sealing portions 215a formed at a portion where the terminal portion 220 is disposed, and a second sealing portion 215b formed at a portion where the terminal portion 220 is not disposed.

For example, the exterior material 210 of the battery cell 100 may include first ends 210E1 and a second end 210E2. The first ends 210E1 and the second end 210E2 may intersect each other. The second end 210E2 may connect the first ends 210E1 facing each other. The first ends 210E1 may be portions of ends of the exterior material 210 at which the terminal portion 220 is disposed. The second end 210E2 may be a portion of the ends of the exterior material 210 at which the terminal portion 220 is not disposed. The first sealing portions 215a may be disposed at the first ends 210E1. The second sealing portion 215b may be disposed at the second end 210E2.

That is, the sealing portion 215 may include the first sealing portions 215a disposed at the first ends 210E1 of the exterior material 210 at which the terminal portion 220 is disposed, and the second sealing portion 215b disposed at the second end 210E2 of the exterior material 210 intersecting the first ends 210E1.

Further, the battery cell 100 of an embodiment of the present disclosure may be provided with the accommodating space 213 in each of the first exterior material 210a and the second exterior material 210b. However, embodiments of the present disclosure are not limited thereto. For example, various modifications are possible, such as providing the accommodating space 213 in only one of the first exterior material 210a and the second exterior material 210b.

In addition, electrode tabs 235 may be disposed between the electrode assembly 230 and the sealing portion 215. The electrode tabs 235 may electrically connect the electrode assembly 230 and the terminal portion 220. A plurality of electrode tabs 235 may extend from the electrode assembly 230 and may be bonded to at least one terminal portion 220.

The terminal portion 220 may include a positive electrode lead and a negative electrode lead. At least a part of the terminal portion 220 may protrude to the outside of the exterior material 210, and the electrode assembly 230 may be electrically coupled to external elements through the terminal portion 220.

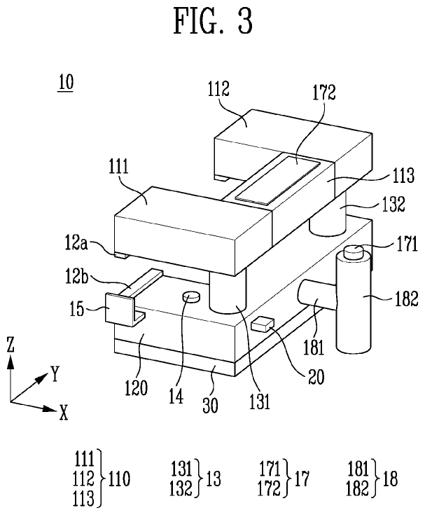

The terminal portion 220 may have a plate shape that protrudes from the inside of the exterior material 210 to the outside thereof. A protruding direction of the terminal portion 220 may be perpendicular to a moving direction of a first pressing portion 110 to be described below. Along an arrangement direction perpendicular to both the protruding direction of the terminal portion 220 and the moving direction of the first pressing portion 110, a length WT of the terminal portion 220 may be less than a length of the first end 210E1. Therefore, when a sealing device (10 of FIG. 3) approaches the terminal portion 220 for resealing the first sealing portion 215a, it is necessary to prevent or mitigate interference with the terminal portion 220.

The battery cell 100 configured in the above-described manner may be manufactured by forming the accommodating space 213 in the exterior material 210 by press working or the like, mounting the electrode assembly 230 in the accommodating space 213, and sealing the accommodating space 213. More specifically, after mounting the electrode assembly 230 in the accommodating space 213 of the exterior material 210, a process of forming the first sealing portion 215a by sealing the portion where the terminal portion 220 is disposed may first be performed. Then, after injecting an electrolyte solution into the accommodating space 213 through a portion where the second sealing portion 215b is to be formed, a process of forming the second sealing portion 215b by sealing the portion where the second sealing portion 215b is to be formed may be performed sequentially.

FIG. 3 is a perspective view illustrating a sealing device according to an embodiment of the present disclosure.

Referring to FIG. 3, the sealing device 10 according to an embodiment of the present disclosure may include pressing portions 110 and 120, sealing bars 12a and 12b, a lifting portion 13, a measuring sensor 14, an alignment portion 15, an input and output (input/output) unit 17, a grip portion 18, an alignment sensor 20, and a power supply unit 30.

The first pressing portion 110 and a second pressing portion 120 may have a recessed U-shape along the direction in which the terminal portion 220 protrudes to prevent or mitigate interference with the terminal portion 220. An opening having a recessed U-shape may be disposed to face the battery cell (100 of FIG. 1) or the terminal portion (220 of FIG. 1), which is to prevent interference of the terminal portion 220 with the first pressing portion 110 and the second pressing portion 120. Because the battery cell 100 further includes additional components, such as an insulating film, at the terminal portion 220, pressing the terminal portion 220 directly through the first pressing portion 110 and the second pressing portion 120 may cause an open circuit in the electrode assembly (230 of FIG. 2).

More specifically, the first pressing portion 110 may include a first wing portion 111 extending along the direction in which the terminal portion 220 protrudes; a second wing portion 112 extending along the direction in which the terminal portion 220 protrudes and disposed to be spaced apart from the first wing portion 111; and a first connection portion 113 disposed to be spaced apart from the battery cell 100 and connecting the first wing portion 111 and the second wing portion 112.

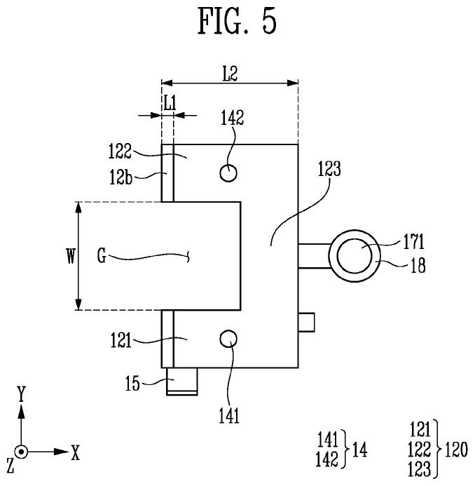

Similarly, the second pressing portion 120 may include a third wing portion (121 in FIG. 5) and a fourth wing portion (122 in FIG. 5) disposed to face the first wing portion 111 and the second wing portion 112, and a second connection portion (123 in FIG. 5) facing the first connection portion 113 and connecting the third wing portion 121 and the fourth wing portion 122.

The first connection portion 113 may connect portions of the first pressing portion 110 spaced apart in a second direction Y. FIG. 3 illustrates an embodiment in which the first connection portion 113 connects the first wing portion 111 and the second wing portion 112 spaced apart from each other, but embodiments are not limited thereto. For example, the first wing portion 111 and the second wing portion 112 spaced apart in the second direction Y may be integrally connected with the first connection portion 113 rather than separated. The relationship between the second connection portion 123, the third wing portion 121, and the fourth wing portion 122 is the same as that described for the first connection portion 113, the first wing portion 111, and the second wing portion 112.

While the first pressing portion 110 presses one surface of the sealing portion (215 of FIG. 1) of the battery cell (100 of FIG. 1), the second pressing portion 120 may press the other surface of the sealing portion (215 of FIG. 1) of the battery cell (100 of FIG. 1). Thus, the first pressing portion 110 may face the second pressing portion 120 over the second pressing portion 120 and press the sealing portion (215 of FIG. 1) of the battery cell (100 of FIG. 1) together with the second pressing portion 120.

The first pressing portion 110 and the second pressing portion 120 may press the sealing portion (215 of FIG. 1) of the battery cell (100 of FIG. 1). For example, the first pressing portion 110 may press the first sealing portion (215a of FIG. 1) from above the first sealing portion (215a of FIG. 1), and the second pressing portion 120 may press the first sealing portion (215a of FIG. 1)from below the first sealing portion (215a of FIG. 1). The first pressing portion 110 and the second pressing portion 120 may press the sealing portion (215 of FIG. 1) interposed therebetween at a set sealing pressure.

To this end, the first pressing portion 110 may further include first sealing bars 12a respectively disposed on one surface facing the third wing portion 121 of surfaces of the first wing portion 111 and on one surface facing the fourth wing portion 122 of surfaces of the second wing portion 112. The second pressing portion 120 may further include second sealing bars 12b respectively disposed on one surface facing the first wing portion 111 of surfaces of the third wing portion 121 and on one surface facing the second wing portion 112 of surfaces of the fourth wing portion 122.

The first sealing bars 12a and the second sealing bars 12b may extend along a direction from the first wing portion 111 toward the second wing portion 112 or a direction from the third wing portion 121 toward the fourth wing portion 122.

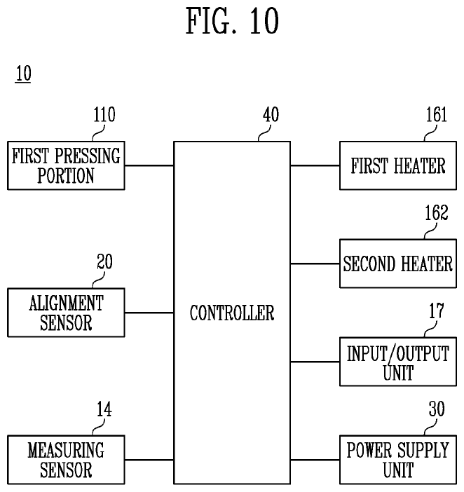

Further, the first pressing portion 110 may transfer thermal energy to the first sealing bars 12a. The second pressing portion 120 may transfer thermal energy to the second sealing bars 12b. For example, the first pressing portion 110 may heat the first sealing bars 12a. The second pressing portion 120 may heat the second sealing bars 12b. To this end, the first pressing portion 110 may further include a first heater (161 of FIG. 10) that heats the first sealing bars 12a. The second pressing portion 120 may further include a second heater (162 of FIG. 10) that heats the second sealing bars 12b.

As described above, the sealing bars 12a and 12b may include the first sealing bars 12a and the second sealing bars 12b. The first sealing bars 12a may be disposed on a lower surface of the first pressing portion 110. The first sealing bars 12a may be disposed at one end of the first pressing portion 110. Alternatively, the first sealing bar 12a may be disposed at one end of each of the first wing portion 111 and the second wing portion 112.

The second sealing bars 12b may be disposed on an upper surface of the second pressing portion 120. The second sealing bars 12b may be disposed at one end of the second pressing portion 120. Alternatively, the second sealing bar 12b may be disposed at one end of each of the third wing portion 121 and the fourth wing portion 122.

The first sealing bars 12a and the second sealing bars 12b may be disposed in parallel. For example, the first sealing bars 12a and the second sealing bars 12b may be spaced apart from each other in a third direction Z. The first sealing bar 12a and the second sealing bar 12b may face each other. The first sealing bars 12a may be disposed to correspond to the second sealing bars 12b.

The first sealing bars 12a may be respectively disposed at ends of the first pressing portion 110 spaced apart in the second direction Y (or in the direction perpendicular to the protruding direction of the terminal portion 220 and the moving direction of the first pressing portion 110). The second sealing bars 12b may be respectively disposed at ends of the second pressing portion 120 spaced apart in the second direction Y.

The first sealing bars 12a and the second sealing bars 12b may seal the sealing portion (215 of FIG. 1) of the battery cell (100 of FIG. 1) by applying heat and pressure. For example, the first sealing bars 12a may seal the first sealing portion (215a of FIG. 1) from above the first sealing portion (215a of FIG. 1), and the second sealing bars 12b may seal the first sealing portion (215a of FIG. 1) from below the first sealing portion (215a of FIG. 1). The first sealing bars 12a and the second sealing bars 12b may be heated by the first pressing portion 110 and the second pressing portion 120, such that the temperature thereof rises.

The lifting portion 13 may be disposed between the first pressing portion 110 and the second pressing portion 120. The lifting portion 13 may connect the first pressing portion 110 and the second pressing portion 120. The lifting portion 13 may move the first pressing portion 110 toward the second pressing portion 120 or away from the second pressing portion 120.

For example, the lifting portion 13 may elevate the first pressing portion 110, and the first pressing portion 110 and the second pressing portion 120 may stop pressing the sealing portion (215 of FIG. 1) of the battery cell (100 of FIG. 1). In another example, the lifting portion 13 may lower the first pressing portion 110, and the first pressing portion 110 and the second pressing portion 120 may press the sealing portion (215 of FIG. 1) of the battery cell (100 of FIG. 1). The lifting portion 13 may include a motor or actuator. However, the lifting portion 13 is not limited to a motor or actuator. The lifting portion 13 may include other driving members capable of moving the first pressing portion 110.

The lifting portion 13 may include a first pillar portion 131 and a second pillar portion 132 disposed along an arrangement direction perpendicular to the moving direction of the first pressing portion 110 and the protruding direction of the terminal portion 220.

The first pillar portion 131 may be disposed close to one side surface of opposite side surfaces of the first pressing portion 110 along the arrangement direction, and the second pillar portion 132 may be disposed close to the other side surface of the opposite side surfaces of the first pressing portion 110 along the arrangement direction.

Referring to FIG. 3, the sealing device 10 according to the present disclosure may further include the measuring sensor 14 located on one of one surface facing the second pressing portion 120 of surfaces of the first pressing portion 110 and one surface facing the first pressing portion 110 of surfaces of the second pressing portion 120 for measuring the thickness of the sealing portion (215 of FIG. 1).

The measuring sensor 14 may measure the thickness of the sealing portion (215 of FIG. 1) of the battery cell (100 of FIG. 1). The measuring sensor 14 may measure the thickness of the sealing portion (215 of FIG. 1) through distance sensing. For example, the measuring sensors 14 may be disposed at the first pressing portion 110 and the second pressing portion 120. More specifically, the measuring sensor 14 may be disposed on at least one of the first wing portion 111, the second wing portion 112, the third wing portion 121, or the fourth wing portion 122. Accordingly, the measuring sensor 14 may detect a distance between the first wing portion 111 and the third wing portion 121 or a distance between the second wing portion 112 and the fourth wing portion 122, thereby calculating the thickness of the sealing portion (215 of FIG. 1) of the battery cell (100 of FIG. 1) disposed between the first pressing portion 110 and the second pressing portion 120.

The sealing device 10 according to the present disclosure may further include the alignment portion 15 located on an outer side of one of the first pressing portion 110 and the second pressing portion 120 for aligning the battery cell 100.

The alignment portion 15 may align the sealing portion (215 of FIG. 1) of the battery cell (100 of FIG. 1) with the first sealing bar 12a and the second sealing bar 12b. For example, the alignment portion 15 may align the sealing portion (215 of FIG. 1) of the battery cell (100 of FIG. 1) with the first sealing bar 12a and the second sealing bar 12b in the second direction Y.

For example, the alignment portion 15 may extend from the outer side of the second pressing portion 120 along an extension direction of the first sealing bar 12a or the second sealing bar 12b, and may be bent toward the first pressing portion 110.

The sealing device 10 according to the present disclosure may further include the input/output unit 17 located at one of the first pressing portion 110 and the second pressing portion 120 and receiving a command from a user.

Specifically, the input/output unit 17 may include an input unit 171 located at the grip portion 18 and an output unit 172 located at the first pressing portion 110. For example, the output unit 172 may include a display unit, such as a display.

The input/output unit 17 may receive input or output parameters of a sealing process for the sealing portion (215 of FIG. 1). For example, the parameters of the sealing process may include at least one of a sealing temperature, a sealing pressure, a sealing thickness, or a sealing time. However, embodiments are not limited thereto. For example, the parameters of the sealing process may further include other parameters in addition to those described above.

For example, in FIG. 3, the input unit 171 may serve as an on/off switch. Alternatively, the input unit 171 may receive the parameters of the sealing process. Alternatively, the output unit 172 may receive the parameters of the sealing process and display the same on a display. The form of the input/output unit 17 is not limited to the form shown in FIG. 3, as long as the input/output unit 17 can receive an input from a user and display a state or a processing result.

An operator sealing the sealing portion (215 of FIG. 1) of the battery cell (100 of FIG. 1) using the sealing device 10 may input the sealing temperature, the sealing pressure, the sealing thickness, the sealing time, or the like via the input/output unit 17. The sealing device 10 may seal the sealing portion (215 of FIG. 1) according to the received parameters of the sealing process. The input/output unit 17 may output the parameters of the sealing process while the sealing process for the sealing portion (215 of FIG. 1) is in progress. For example, the input/output unit 17 may output a temperature at which the sealing portion (215 of FIG. 1) is sealed via a display unit. In another example, the input/output unit 17 may output the sealing temperature and pressure for the first sealing bars 12a and the second sealing bars 12b.

The second pressing portion 120 may further include the grip portion 18 provided thereto to allow a user to grip.

For example, the grip portion 18 may be disposed at a rear surface of a portion connecting portions of the second pressing portion 120 spaced apart in the second direction Y. For example, the grip portion 18 may be disposed in a direction opposite to the battery cell 100 with respect to the first pressing portion 110 and the second pressing portion 120.

The grip portion 18 may be gripped. For example, the operator using the sealing device 10 may grip the grip portion 18 to lift the sealing device 10. The operator using the sealing device 10 may grip the grip portion 18 to lift and move the sealing device 10.

Specifically, the grip portion 18 may include a protrusion 181 protruding from the second pressing portion 120 and an extension 182 extending along a direction from the first pressing portion 110 toward the second pressing portion 120.

The input unit 171 may be disposed on the grip portion 18. However, embodiments are not limited thereto. For example, the input unit 171 may be disposed on the second pressing portion 120. A signal for operation of the sealing device 10 may be input via the input unit 171. For example, the operator using the sealing device 10 may control turning the sealing device 10 on or off using the input unit 171. The operator using the sealing device 10 may control the operation of the sealing device 10 by pressing the input unit 171.

The sealing device 10 according to the present disclosure may further include the alignment sensor 20 located on the first pressing portion 110 or the second pressing portion 120 and detect whether the first pressing portion 110 and the second pressing portion 120 are aligned.

For example, the alignment sensor 20 may be disposed on the second pressing portion 120 the same as the alignment portion 15. However, embodiments are not limited thereto. For example, the alignment sensor 20 may be disposed on one surface of one of the third wing portion, the fourth wing portion, or the second connection portion 123, such as one surface in the direction in which the grip portion 18 protrudes.

The alignment sensor 20 may detect whether the battery cell (100 of FIG. 1) is horizontally aligned. For example, the alignment sensor 20 may detect whether the battery cell (100 of FIG. 1) is positioned level on the second pressing portion 120. When the alignment sensor 20 sends, to a controller, a signal indicating that the battery cell (100 of FIG. 1) is horizontally aligned, the sealing device 10 may start sealing. In contrast, when the alignment sensor 20 sends, to the controller, a signal indicating that the battery cell (100 of FIG. 1) is not horizontally aligned, the sealing device 10 may stop sealing.

For example, the alignment sensor 20 may be a gyro sensor.

When the operator operating the sealing device 10 holds the sealing device 10 by directly gripping the grip portion 18 and seals the sealing portion (215 of FIG. 1) of the battery cell (100 of FIG. 1), the sealing device 10 and the battery cell (100 of FIG. 1) might not be stably aligned due to the movement of the operator, the vibration of a hand, or the like. By detecting, via the alignment sensor 20, whether the battery cell (100 of FIG. 1) is horizontally aligned, the accuracy of sealing may be improved even when the operator directly grips the grip portion 18 to seal the sealing portion (215 of FIG. 1) of the battery cell (100 of FIG. 1).

The power supply unit 30 may be disposed below the second pressing portion 120. That is, the power supply unit 30 may be disposed closer to the second pressing portion 120 than the first pressing portion 110. When the first pressing portion 110 and the second pressing portion 120 are arranged along the direction of gravity, the center of gravity of the sealing device 10 according to the present disclosure may be located at a lower portion, thereby improving the operational stability of the sealing device 10. In other words, the vibration during operation of the sealing device 10 may be relatively smaller than when the power supply unit 30 is closer to the first pressing portion 110.

The power supply unit 30 may store the required power and then supply the same for operation of the sealing device 10. Specifically, the power supply unit 30 may provide the power required to operate the sealing device 10 in a wireless manner rather than a wired (or cabled) manner. For example, the power supply unit 30 may include a rechargeable portable battery to supply power wirelessly. As the power supply unit 30 provides the power required to operate the sealing device 10, spatial constraints for using the sealing device 10 may be alleviated or reduced. The operator may seal the battery cell (100 of FIG. 1) at any location by gripping the grip portion 18 and move the sealing device 10.

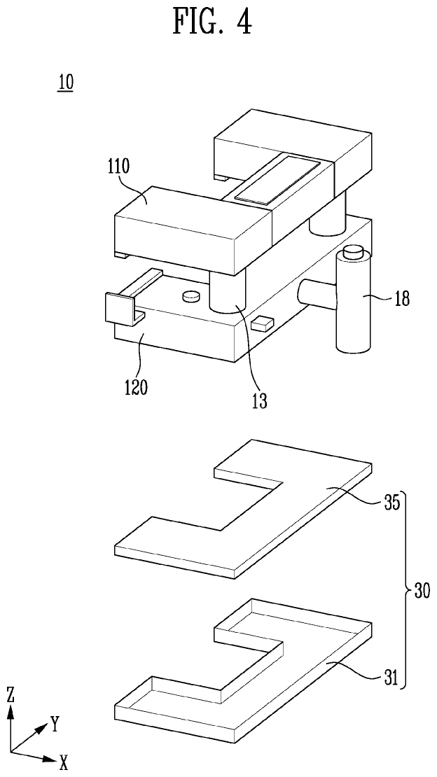

The power supply unit 30 will be described in more detail with reference to FIG. 4. FIG. 4 is an exploded view illustrating a sealing device according to an embodiment of the present disclosure. For ease of description, differences from those described with reference to FIG. 3 will be mainly described.

Referring to FIG. 4, the power supply unit 30 may include a case 31 and a portable battery 35. The power supply unit 30 may include the portable battery 35 that is disposed below the second pressing portion 120 and is charged and discharged. The portable battery 35 may be mounted within the case 31. The case 31 may protect the portable battery 35 from the outside. The planar shape of the case 31 may be the same as the planar shape of the second pressing portion 120. However, embodiments are not limited thereto. For example, the power supply unit 30 might not overlap the entire lower surface of the second pressing portion 120, but may only partially cover the second pressing portion 120.

The portable battery 35 may be disposed in the case 31. For example, the portable battery 35 may include a lithium secondary battery. However, embodiments are not limited thereto. The portable battery 35 may be repeatedly charged and discharged. The pre-charged portable battery 35 may be used to wirelessly power the sealing device 10.

FIG. 4 illustrates the portable battery 35 in a U-shaped configuration, but the portable battery 35 may be configured in other shapes.

Thus, referring to FIGS. 3 and 4, the sealing device 10 according to the present disclosure may include the first pressing portion 110 and the second pressing portion 120 disposed to face each other with at least a portion of the exterior material (210 of FIG. 1) interposed therebetween to contact the sealing portion (215 of FIG. 1) formed on at least a portion of the exterior material 210 along a periphery of the accommodating space 213 to seal the accommodating space 213 and may include the lifting portion 13 for moving the first pressing portion 110 toward or away from the second pressing portion 120 to contact the sealing portion 215 disposed at the first pressing portion 110 and the second pressing portion 120.

FIG. 5 is a cross-sectional view illustrating a sealing device according to an embodiment of the present disclosure. For ease of description, differences from those described with reference to FIG. 3 will be mainly described. FIG. 5 shows a plan view of the second pressing portion 120.

Referring to FIG. 5, the alignment portion 15 may be disposed on a side surface of the second pressing portion 120 in the second direction Y. The second pressing portion 120 may include a groove portion G. For example, the groove portion G may be disposed between portions of the second pressing portion 120 that are spaced apart in the second direction Y and extend parallel to each other in a first direction X. When the first sealing portion (215a of FIG. 1) formed at the portion where the terminal portion (220 of FIG. 1) is disposed is sealed, the terminal portion (220 of FIG. 1) may be disposed in the groove portion G so that the terminal portion (220 of FIG. 1) is not damaged.

The second sealing bars 12b may be disposed at an end of the second pressing portion 120 in the first direction X. The measuring sensor 14 may include a plurality of measuring sensors, which may be disposed on the portions of the second pressing portion 120 extending parallel to each other in the first direction X. For example, the measuring sensor 14 may include a first measuring sensor 141 and a second measuring sensor 142 respectively disposed on the third wing portion 121 and the fourth wing portion 122.

Referring to FIG. 5, the third wing portion 121 and the fourth wing portion 122 extending from the second connection portion 123 may form the groove portion G between each other in which at least a portion of the battery cell (100 of FIG. 1) is disposed.

In the groove portion G, a distance W between the third wing portion 121 and the fourth wing portion 122 along a direction(e.g., Y direction) perpendicular to the protruding direction (e.g., X direction) of the terminal portion (220 of FIG. 1) and the moving direction (e.g., Z direction) of the first pressing portion 110 may be greater than or equal to the length WT of the terminal portion (220 of FIG. 1).

The direction (or the arrangement direction) perpendicular to the protruding direction of the terminal portion 220 and the moving direction of the first pressing portion 110 may be an extension direction of the second connection portion 123 or the first connection portion (113 of FIG. 3).

Furthermore, along the protruding direction of the terminal portion 220, a length L1 of the second sealing bar may be less than a length L2 of the third wing portion 121 or the length L2 of the fourth wing portion 122. Similarly, along the protruding direction of the terminal portion 220, a length of the first sealing bar may be less than a length of the first wing portion (111 of FIG. 3) or a length of the second wing portion (112 of FIG. 3).

Referring to FIG. 5, along the protruding direction of the terminal portion 220, the grip portion 18 may be disposed in a direction opposite to the battery cell 100 with the second pressing portion 120 interposed therebetween. The input unit 171 positioned on the grip portion 18 may also be disposed in the direction opposite to the battery cell 100 with the second pressing portion 120 interposed therebetween.

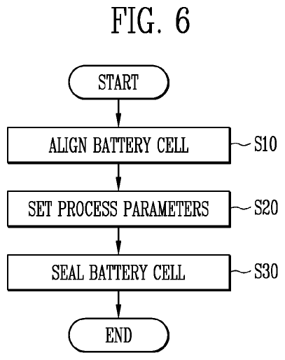

FIG. 6 is a flowchart illustrating a sealing method according to an embodiment of the present disclosure.

Referring to FIG. 6, a sealing method according to an embodiment of the present disclosure may include aligning a battery cell (S10).

For example, the sealing portion (215 of FIG. 1) of the battery cell (100 of FIG. 1) may be aligned with the first sealing bars (12a of FIG. 3) and the second sealing bars (12b of FIG. 3) of the sealing device (10 of FIG. 3).

Subsequently, the sealing method may include setting sealing process parameters via the input/output unit 17 (S20).

For example, parameters such as a sealing temperature, a sealing pressure, a sealing thickness, and a sealing time may be set depending on an extent to which the sealing portion (215 of FIG. 1) of the battery cell (100 of FIG. 1) needs to be sealed.

Subsequently, the sealing method may include sealing the battery cell (S30).

According to the set sealing process parameters, the sealing portion (215 of FIG. 1) of the battery cell (100 of FIG. 1) may be pressed and sealed using the sealing device (10 of FIG. 3).

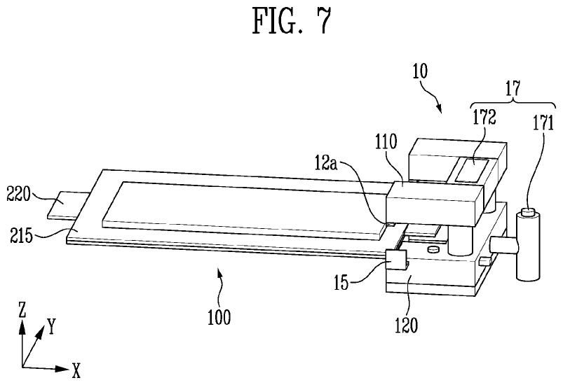

Hereinafter, a sealing method will be described in detail with reference to FIGS. 7 to 9.

FIG. 7 is a diagram illustrating a sealing method according to an embodiment of the present disclosure.

Referring to FIG. 7, a sealing method according to an embodiment of the present disclosure may include aligning the battery cell 100 with the sealing device 10 (S10 of FIG. 6).

For example, the alignment sensor 20 may be used to detect whether the battery cell 100 and the sealing device 10 are horizontally aligned.

Further, the alignment portion 15 may be used to adjust the first pressing portion 110 and the second pressing portion 120 such that the sealing portion 215 of the battery cell 100 is aligned with the first sealing bar 12a and the second sealing bar (12b of FIG. 3).

Subsequently, the sealing method according to an embodiment of the present disclosure may include setting the sealing process parameters via the input/output unit 17 including the input unit 171 and the output unit 172 (S20 of FIG. 6).

An operator sealing the sealing portion 215 of the battery cell 100 using the sealing device 10 may input the sealing temperature, the sealing pressure, the sealing thickness, and the sealing time, or the like via the input/output unit 17. The input/output unit 17 may output the received sealing process parameters.

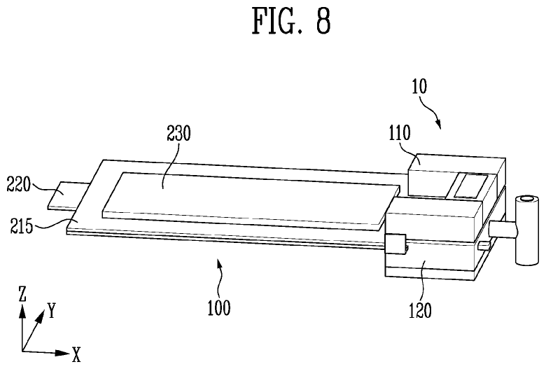

FIG. 8 is a diagram illustrating a sealing method according to an embodiment of the present disclosure.

Referring to FIG. 8, a sealing method according to an embodiment of the present disclosure may include sealing the battery cell 100 (S30 of FIG. 6).

Specifically, the first pressing portion 110 and the second pressing portion 120 may press the sealing portion 215 from above and from below the sealing portion 215. By the pressing of the first pressing portion 110 and the second pressing portion 120, the first sealing bar (12a of FIG. 3) and the second sealing bar (12b of FIG. 3) may seal the sealing portion 215 by applying heat and pressure.

When the first pressing portion 110 and the second pressing portion 120 press the sealing portion 215, the thickness of the sealing portion 215 may be measured in real time. Specifically, when the sealing portion 215 is pressed, the thickness of the sealing portion 215 may be measured in real time using the measuring sensor (14 of FIG. 3).

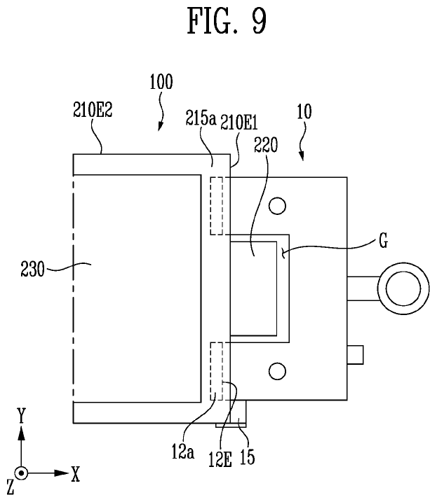

FIG. 9 is a diagram illustrating a sealing method according to an embodiment of the present disclosure.

Referring to FIG. 9, the first sealing bars 12a may be aligned with the first sealing portion 215a such that the first sealing bars 12a are spaced apart from the first end 210E1 and the second end 210E2 of the exterior material 210 of the battery cell 100. Similarly, the second sealing bars 12b may be aligned with the first sealing portion 215a such that the second sealing bars 12b are spaced apart from the first end 210E1 and the second end 210E2 of the exterior material 210 of the battery cell 100. Further, the terminal portion 220 disposed at the first end 210E1 may be disposed in the groove portion G of the sealing device 10.

For example, when the first sealing portion 215a is sealed, the first sealing bars 12a and the second sealing bars 12b may be aligned between the electrode assembly 230 and the first end 210E1 in the first direction X to seal the first sealing portion 215a. Specifically, an inner end 12E of each of the first sealing bar 12a and the second sealing bar 12b adjacent to the first end 210E1 may be spaced apart from the first end 210E1 such that the inner end 12E is disposed between the electrode assembly 230 and the first end 210E1 in the first direction X.

The first sealing portion 215a and the second sealing portion (215b of FIG. 1), which are sealed by heat and pressure, may include an adhesive material that is thermally adhesive on inner surfaces thereof to be attached. For example, an adhesive such as a polyolefin-based resin material or a modified Casted Polypropylene (CPP) may be formed on the inner surfaces to be attached of the first sealing portion 215a and the second sealing portion (215b of FIG. 1).

When the inner ends 12E of the first sealing bars 12a and the second sealing bars 12b are aligned to contact the first end 210E1 and the second end 210E2 and are sealed, the adhesive material formed on the inner surfaces of the first sealing portion 215a and the second sealing portion (215b of FIG. 1) may be discharged outward. Therefore, by spacing the first sealing bars 12a and the second sealing bars 12b apart from the first end 210E1 and the second end 210E2 and aligning the first sealing bars 12a and the second sealing bars 12b inward toward the electrode assembly 230, the outward discharge of the adhesive material formed on the inner surfaces of the first sealing portion 215a and the second sealing portion (215b of FIG. 1) may be suppressed or reduced.

FIG. 10 is a control block diagram of a sealing device according to an embodiment of the present disclosure.

The sealing device 10 according to an embodiment of the present disclosure may further include a controller 40. The controller 40 may control movement of the first pressing portion 110. The controller 40 may determine information detected via the alignment sensor 20 and the measuring sensor 14.

Further, the controller 40 may heat the first sealing bars 12a via the first heater 161 and the second sealing bars 12b via the second heater 162.

Further, the controller 40 may control the input/output unit 17 and control the power supply unit 30.

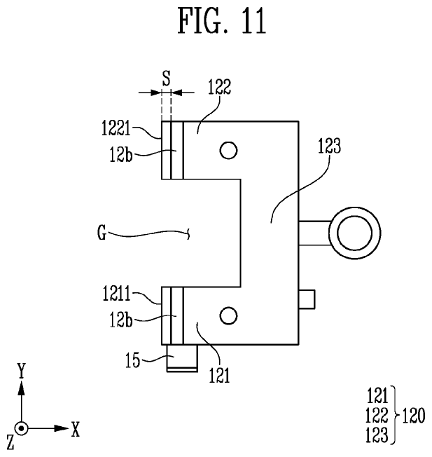

FIG. 11 is a diagram illustrating sealing bars of a sealing device according to an embodiment of the present disclosure.

Specifically, FIG. 11 illustrates another example of the second sealing bars 12b.

Referring to FIG. 11, along the protruding direction of the terminal portion (220 of FIG. 1), the second sealing bars 12b may be disposed on the third wing portion 121 and the fourth wing portion 122 while being spaced apart from an end 1211 of the third wing portion and an end 1221 of the fourth wing portion by a predetermined distance S.

This is to prevent or mitigate the PP layer of the exterior material from being extruded when the first pressing portion (110 of FIG. 3) and the second pressing portion (120 of FIG. 3) heat and press the exterior material (210 of FIG. 1).

As described above, the first wing portion (111 of FIG. 3) and the second wing portion (112 of FIG. 3) are disposed to correspond to the third wing portion 121 and the fourth wing portion 122, and the positions of the first sealing bars (12a of FIG. 3) on the first wing portion 111 and the second wing portion 112 may correspond to the positions of the second sealing bars 12b on the third wing portion 121 and the fourth wing portion 122.

Thus, along the protruding direction of the terminal portion (220 of FIG. 1), the first sealing bars 12a may be disposed on the first wing portion 111 and the second wing portion 112 while being spaced apart from an end (not shown) of the first wing portion and an end (not shown) of the second wing portion by the predetermined distance S.

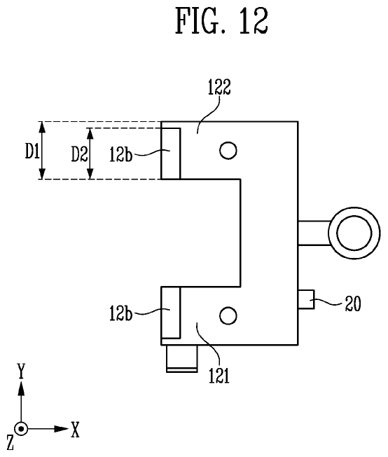

FIG. 12 is a diagram illustrating sealing bars of a sealing device according to an embodiment of the present disclosure.

Specifically, FIG. 12 illustrates still another example of the second sealing bars 12b.

Referring to FIG. 12, a length D2 of each of the second sealing bars 12b along a direction (or arrangement direction) from the third wing portion 121 toward the fourth wing portion 122 may be less than or equal to a length D1 of each of the third wing portion 121 and the fourth wing portion 122.

As in FIG. 11, this is to prevent or mitigate the PP layer of the exterior material from being extruded when the first pressing portion (110 of FIG. 3) and the second pressing portion (120 of FIG. 3) heat and press the exterior material (210 of FIG. 1).

As described above, the first wing portion (111 of FIG. 3) and the second wing portion (112 of FIG. 3) are disposed to correspond to the third wing portion 121 and the fourth wing portion 122, and the positions of the first sealing bars (12a of FIG. 3) on the first wing portion 111 and the second wing portion 112 may correspond to the positions of the second sealing bars 12b on the third wing portion 121 and the fourth wing portion 122.

Thus, a length of each of the first sealing bars 12a along a direction from the first wing portion 111 toward the second wing portion 112 may be less than or equal to a length of each of the first wing portion 111 and the second wing portion 112.

The descriptions as set forth above are merely examples to which the principles of the present disclosure are applied, and other configurations may be further included without departing from the scope of the present disclosure.

What is claimed is:

1. A sealing device for a battery cell comprising an exterior material that forms an accommodating space accommodating an electrode assembly therein and a terminal portion that is connected to the electrode assembly and protrudes to an outside of the exterior material, the sealing device comprising:
a first pressing portion and a second pressing portion disposed to face each other with at least a portion of the exterior material interposed therebetween to contact a sealing portion, wherein the sealing portion is formed on the at least the portion of the exterior material along a periphery of the accommodating space to seal the accommodating space; and
a lifting portion for moving the first pressing portion toward or away from the second pressing portion to contact the sealing portion disposed at the first pressing portion and the second pressing portion.

2. The sealing device of claim 1, wherein the first pressing portion comprises:
a first wing portion extending along a direction in which the terminal portion protrudes;
a second wing portion extending along the direction in which the terminal portion protrudes and disposed to be spaced apart from the first wing portion; and
a first connection portion disposed to be spaced apart from the battery cell and connecting the first wing portion and the second wing portion, and
wherein the second pressing portion comprises:
a third wing portion and a fourth wing portion disposed to face the first wing portion and the second wing portion; and
a second connection portion facing the first connection portion and connecting the third wing portion and the fourth wing portion.

3. The sealing device of claim 2, wherein the first pressing portion further comprises first sealing bars respectively disposed on one surface facing the third wing portion of surfaces of the first wing portion and on one surface facing the fourth wing portion of surfaces of the second wing portion, and
wherein the second pressing portion further comprises second sealing bars respectively disposed on one surface facing the first wing portion of surfaces of the third wing portion and on one surface facing the second wing portion of surfaces of the fourth wing portion.

4. The sealing device of claim 3, wherein the first sealing bars and the second sealing bars extend along a direction from the first wing portion toward the second wing portion or a direction from the third wing portion toward the fourth wing portion.

5. The sealing device of claim 3, wherein, along the direction in which the terminal portion protrudes, a length of each of the first sealing bars and the second sealing bars is less than a length of the first wing portion, a length of the second wing portion, a length of the third wing portion, or a length of the fourth wing portion.

6. The sealing device of claim 3, wherein, along a direction from the first wing portion toward the second wing portion, a length of each of the first sealing bars is less than or equal to a length of each of the first wing portion and the second wing portion, and
wherein, along a direction from the third wing portion toward the fourth wing portion, a length of each of the second sealing bars is less than or equal to a length of each of the third wing portion and the fourth wing portion.

7. The sealing device of claim 5, further comprising an alignment portion located on an outer side of one of the first pressing portion and the second pressing portion for aligning the battery cell.

8. The sealing device of claim 7, wherein the alignment portion extends from the outer side of the second pressing portion along an extension direction of the first sealing bars or the second sealing bars and is bent toward the first pressing portion.

9. The sealing device of claim 5, wherein the first pressing portion further comprises a first heater heating the first sealing bars, and
wherein the second pressing portion further comprises a second heater heating the second sealing bars.

10. The sealing device of claim 1, further comprising a power supply unit disposed closer to the second pressing portion than the first pressing portion and supplying stored power to the first pressing portion, the second pressing portion, or the lifting portion.

11. The sealing device of claim 1, further comprising an alignment sensor located on the first pressing portion or the second pressing portion and detecting whether the first pressing portion and the second pressing portion are aligned.

12. The sealing device of claim 11, wherein the alignment sensor is a gyro sensor.

13. The sealing device of claim 1, further comprising a measuring sensor located on one of one surface facing the second pressing portion of surfaces of the first pressing portion and one surface facing the first pressing portion of surfaces of the second pressing portion for measuring a thickness of the sealing portion.

14. The sealing device of claim 1, wherein the second pressing portion further comprises a grip portion provided to the second pressing portion to allow a user to grip.

15. The sealing device of claim 14, wherein the grip portion comprises:
a protrusion protruding from the second pressing portion; and
an extension extending along a direction from the first pressing portion toward the second pressing portion.

16. The sealing device of claim 14, wherein the grip portion is disposed in a direction opposite to the battery cell with respect to the first pressing portion and the second pressing portion.

17. The sealing device of claim 14, further comprising an input and output (input/output) unit located at one of the first pressing portion and the second pressing portion and receiving a command from the user.

18. The sealing device of claim 17, wherein the input/output unit comprises:
an input unit located at the grip portion; and
an output unit located at the first pressing portion.

19. The sealing device of claim 1, wherein the lifting portion comprises a first pillar portion and a second pillar portion disposed along an arrangement direction perpendicular to a direction from the first pressing portion toward the second pressing portion and a direction in which the terminal portion protrudes.

20. The sealing device of claim 19, wherein the first pillar portion is disposed close to one side surface of opposite side surfaces of the first pressing portion along the arrangement direction, and
wherein the second pillar portion is disposed close to the other side surface of the opposite side surfaces of the first pressing portion along the arrangement direction.
